(19) United States
(12) Patent Application Publication
(10) Pub. No.: US 2001/0025322 A1
(43) Pub. Date: Sep. 27, 2001

(54) Internet protocol interfacing apparatus for controlling non IP-based network device with IP-based network device and method therefor

(76) Inventors: Jung-Ho Song, Suwon-shi (KR); Hoon-Soon Choi, Seoul (KR)

Correspondence Address: SUGHRUE, MION, ZINN, MACPEAK & SEAS, PLLC, 2100 Pennsylvania Avenue, N.W., Washington, DC, 20037-3202, US

(21) Appl. No.: 09/812,567

(22) Filed: Mar. 21, 2001

(30) Foreign Application Priority Data
Mar. 22, 2000 (KR) 2000-14521

(51) Int. Cl. G06F 15/16

(52) U.S. Cl. 709/249; 709/203

(57) ABSTRACT

Remote control access over certain electronic devices through computer networks is disclosed. Particularly, an internet protocol (IP) interfacing apparatus for controlling non IP-based network devices with IP-based network devices and a method therefor is disclosed. The IP interfacing apparatus according to the present invention includes a dynamic home page assisting section for collecting information on the predetermined electronic devices to assist in construction and processing of a dynamic home page in accordance with assistance in construction of a dynamic web server, and a function control converting section for converting a function control demand by the IP-based networks to a function control of the non IP-based networks by converting a predetermined function selected through HTTP in said IP-based networks to a control command in said non IP-based network.

### BACKGROUND OF THE INVENTION

1. Field of the Invention

The present invention relates to a technology of a remote control and access of certain electronic devices, and more particularly to an internet protocol (IP) interfacing apparatus for controlling certain non-IP based electronic devices with IP-based network devices and a method for the same. The present application is based on Korean Patent Application No. 14521-2000, filed on Mar. 22, 2000, which is incorporated herein by reference.

2. Description of the Related Art

With a rapid distribution of personal computers, internet has made inroads into our daily lives as a network. Thus, the internet has become a keynote of our life and work.

In general, computer networks can be constructed in diverse ways in accordance with the manners applicable to each stack and layer of the protocol. In the internet, as mentioned above, the network is based on internet protocol (IP) of three layers.

However, diverse non IP-based and independent networks also exist. For the terminals and electronic devices of such networks, a problem arises that access or control over those devices is not available with IP-based network devices. The reason lies in a difference of the protocol stack structures between the two kinds of networks.

In short, the terminals and certain electronic devices for non IP-based networks cannot be accessed or controlled by terminals or electronic devices of IP networks.

For instance, private networks such as “home networks” or “corporate networks” are constructed and used on an independent basis. In that case, those networks generally have their own protocols. Because of the different stack structures of the IP networks and protocols, however, mutual access or control is not available between the terminals and devices for their respective networks.

While there has been a demand to control certain electronic devices of those private networks through the internet, no remedy has yet been suggested to resolve the problem.

In recent days, there is a demand for an interfacing apparatus to access or control the devices of non-IP based networks, such as private networks, by means of the terminals or electronic devices of IP-based networks that are most widely used. Nevertheless, no particular remedy or interfacing apparatus has yet been suggested to meet the demand.

### SUMMARY OF THE INVENTION

It is, therefore, an object of the present invention to provide an interfacing apparatus and a method for controlling non IP-based network devices with IP-based network devices.

To achieve the above object, there is provided an interfacing apparatus for controlling non-IP based network devices with IP-based network devices, comprising: a dynamic home page assisting section for collecting information on predetermined electronic devices in a non-IP based network, and assisting construction and processing of a dynamic home page in accordance with assistance in construction of a dynamic web server; and a function control converting section for converting a demand for functional control of the IP-based network to a functional control of the non IP-based network by converting a predetermined function selected through HTTP in said IP-based networks to a control command in said non IP-based network.

### BRIEF DESCRIPTION OF THE DRAWINGS

The above objects, features and advantages of the present invention will become more apparent from the following detailed description when taken in conjunction with the accompanying drawings, in which:

FIG. 1 is a block diagram illustrating a state of topology for internetworking according to an embodiment of the present invention;

FIG. 2 is a block diagram illustrating a protocol stack of an IP interfacing apparatus according to a preferred embodiment of the present invention;

FIG. 3 is a block diagram illustrating a protocol stack of an IP interfacing apparatus according to another embodiment of the present invention;

FIG. 4 is a flow chart illustrating the flow of a control signal in accordance with an IP protocol having the stack in FIG. 2;

FIG. 5 is a flow chart illustrating the flow of a control signal in accordance with an IP protocol having the stack in FIG. 3;

FIG. 6 is a block diagram illustrating a stack of an IP interface apparatus according to an embodiment satisfying IEEE1394 and the Ethernet pact;

FIG. 7 is a block diagram illustrating a varied stack of an IP interface apparatus according to another embodiment satisfying IEEE1394 and the Ethernet pact;

FIG. 8 is a block diagram illustrating an embodiment of an inner structure of a converting section commonly shown in FIGS. 6 and 7;

FIG. 9 is a flow chart illustrating the state of interfacing from a non IP-based network to an IP-based network as a dynamic home page construction according to a preferred embodiment of the present invention;

FIG. 10 is a flow chart illustrating the state of interfacing from a non-IP network to an IP-based network as a dynamic home page construction according to another preferred embodiment of the present invention; and

FIG. 11 is a block diagram illustrating a construction of hardware in an independent interfacing apparatus satisfying IEEE1394 and the Ethernet pact according to a preferred embodiment of the present invention.

### DETAILED DESCRIPTION OF THE PREFERRED EMBODIMENT

A preferred embodiment of the present invention will now be described with reference to the accompanying drawings. In the following description, the same drawing reference numerals are used for the same elements, even in different drawings. A detailed construction and circuit elements are described only to assist in a comprehensive understanding of the invention. Thus, it will be apparent that the present invention can be carried out without these particulars. Also, well-known functions or constructions are not described in detail since they would obscure the invention in unnecessary detail.

The present invention deals with functions of an interfacing apparatus and a structure of a protocol stack. While there may be diverse non IP-based networks, the following description will be focused on home networks of a small scale where the present invention may be best applicable.

A noteworthy pact of home networks, to which the present invention is applicable, is IEEE1394. IEEE1394 is a high-speed serial interface standard suggested and led by Apple Computer Inc., an American corporation. This standard assists in simultaneous non-synchronous transmission, and is applied to and used as an interface of digital home appliances such as A/V appliances. While the scope of this invention extends beyond application to home networks, a detailed description of the invention, as applied to such networks, will be illustrative as to the operation of the invention.

The IP (internet protocol) is a protocol used for the internet that is applicable to three network layers.

Home audio video interoperability (HAVi) is one example of a software model to which the invention is applicable. The HAVi is a software model developed by eight corporations in Europe and Japan including SONY Corp. to realize a mutual connection between A/V appliances by means of an IEEE1394 network. A self-describing device (SDD) provides basic information on the HAVi node. A device control module is a function control module for controlling the HAVi node.

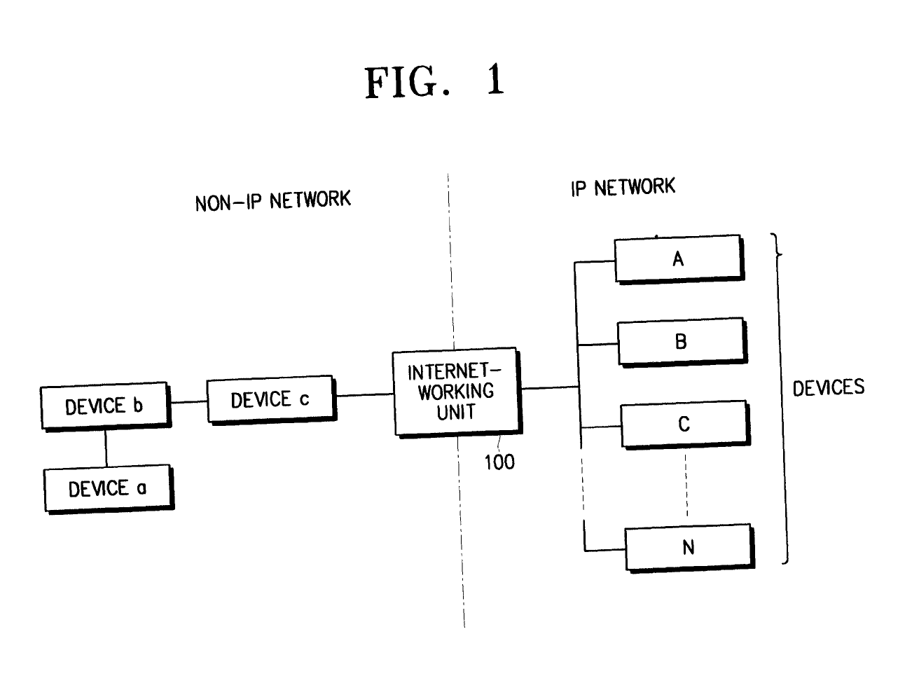

The following is a description of a topology state for internetworking made with reference FIG. 1 according to an embodiment of the present invention.

The network using a protocol of three different layers generally uses subordinate layers, as well, in separate manners. As shown in FIG. 1, an internetworking unit 100 is used for connecting an IP-based network to a non IP-based network. The internetworking unit 100 may be embodied either as an independent unit to perform functions such as packet translation for networking in different styles, a control agent, or as a dependent unit included as a part in an existing appliance to perform the same function.

The internetworking unit 100 includes an IP interfacing apparatus, through which IP-based network devices A, B, C, . . . N can be connected to non IP-based network devices a, b, c, . . . n.

The internetworking unit according to the present invention is not limited to either the independent style or dependent styles.

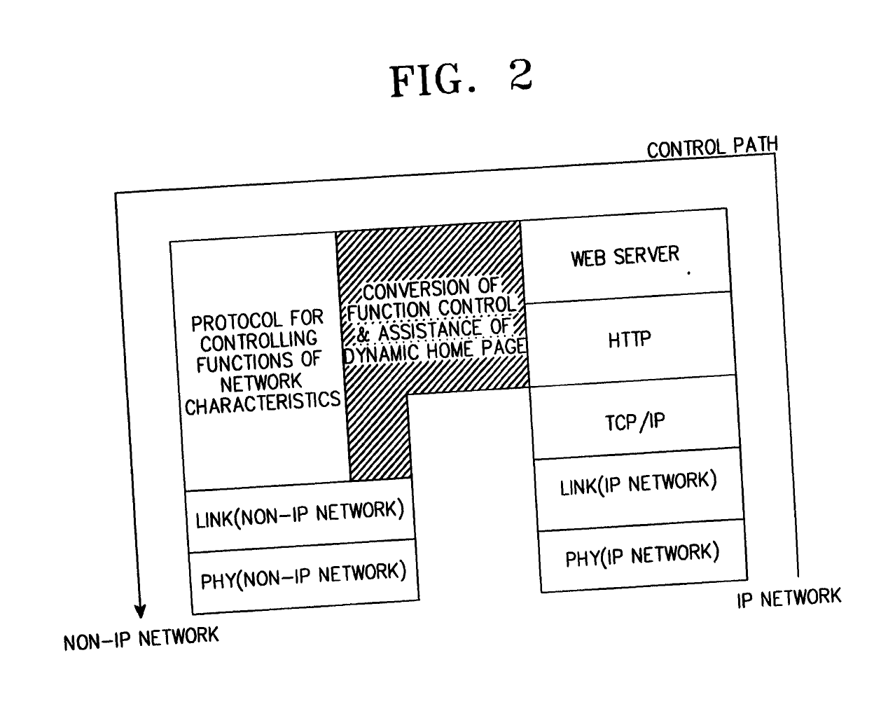

FIG. 2 is a block diagram illustrating a protocol stack of an IP interfacing apparatus according to a preferred embodiment of the present invention. Referring to FIG. 2, the protocol stack has two conditions of ordinary interface to control non IP-based networks from IP-based networks.

The first condition is to get access from an IP-based network to a web base. The second condition is to standardize a protocol for function control between the appliances in non IP-based networks.

The structure illustrated in FIG. 2 is an independent style, which can connect two different networks and perform functions required by the above two conditions as a part of one hardware apparatus.

The section filled with hatched lines represents the function control conversion and dynamic home page assistance. The section mainly performs two different functions.

The first function is to assist in construction and processing of a dynamic home page, i.e., to collect information on the appliances in non IP-based networks and assist in construction of a web server.

The second function is to convert a demand for functional control in the IP-based networks to a function control command in the non IP-based networks. This function is performed by converting a predetermined function selected through HTTP in IP-based networks to an appropriate control command in non IP-based networks.

The above method enables the IP-based network apparatus to learn the existence and functions of each device in a non IP-based network by means of a home page based on the web server shown in FIG. 2, and to control the functions of each device as shown on the web.

However, the above method poses the following problem. If the non IP-based network device is a predetermined one, once it is determined that the device is connected, the function of the device is predetermined. Thus, a dynamic home page can be constructed. If the non IP-based network device is not a predetermined one, only the basic information, including the kind of device, is available, without detailed functions therefor. Thus, although a widely-known key function may be performed by reference to the kind of device, it is impossible to construct or process a home page grasping the overall functions thereof.

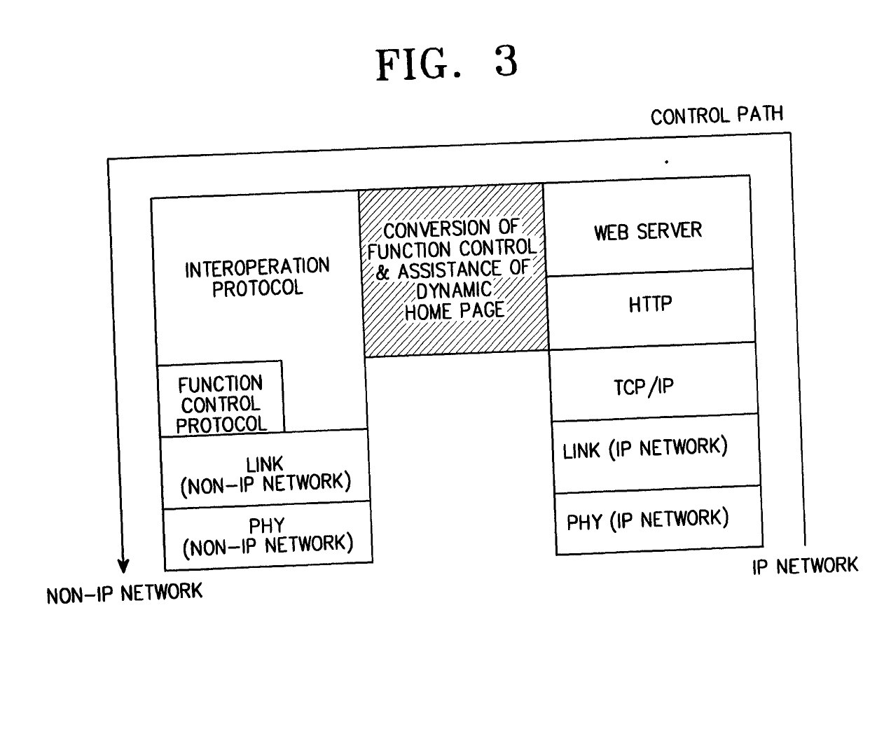

Accordingly, the following three conditions should be satisfied in the case where an IP interfacing apparatus is used to control a non IP-based network device from an IP-based network device, as suggested in another embodiment of the present invention shown in FIG. 3.

First, the access should be based on the web in a web-based network. Second, the protocol for functional control between the devices should be standardized in a non IP-based network. Third, the protocol should be standardized so that information on the functions of the devices in non IP-based networks can be available and so that mutual control can be easily performed in an improved way.

The interoperation protocol of the interfacing apparatus shown in FIG. 3 satisfies the above conditions. The protocols normally belonging to this category are HAVi, Jini, UPNP, etc. Of these protocols, HAVi is applicable to non IP-based networks. Although HAVi is fundamentally based on an IEEE1394 interface, it is applicable to other non IP-based networks if relevant correction is made on an interfacing part with subordinate layers.

In another embodiment of the present invention, the structure shown in FIG. 3 is an independent style that can connect two networks and may perform the above functions as part of a device, depending on the circumstances.

Accordingly, the hatched lines, as shown in FIG. 3, in the middle of the network protocol stack represents an interfacing apparatus for performing the following two functions.

The basic functions, which are the same as shown in FIG. 2, are the same in an ordinary interfacing apparatus, however, the detailed contents are different.

To be specific, the first function is to assist in constructing a dynamic web server by collecting information on the devices in non IP-based networks.

By contrast, the interfacing apparatus shown in FIG. 2 collects information on the devices in non IP-based networks either with an assistance from the function control protocol or directly through subordinate layers. The interfacing apparatus as shown in FIG. 3, however, uses the information about each apparatus that is collected from the interoperation protocol region.

The second function is to convert the demand for functional control of the IP-based networks to a function control command of non IP-based networks. If a predetermined function is selected through HTTP in IP-based networks, the function is converted to a relevant control command in non IP-based networks. If the target devices do not assist in the interoperation protocol, the processing is performed only by the functional control protocol in a manner suggested by a normal interface. This process can be performed by the interfacing apparatus, as shown in FIG. 1. When assisting in the internal operative protocol, however, even a device that has not been predetermined can dynamically recognize the connecting function, construct a home page and suitably convert a demand for functional control.

The device in IP-based networks can learn the existence and functions of each device in non IP-based networks through a home page of the web server shown in FIG. 3, thereby controlling the functions shown on the web only.

In short, the interfacing apparatus shown in FIG. 3 is the one supplementing the drawbacks of the ordinary interfacing apparatus shown in FIG. 2. Even if a non IP-based network device that has not been predetermined is connected, functions of the pertinent device can be learned by using the protocol of a higher level, and, subsequently, the diverse additional functions can also be provided.

If the non IP-based network device assists in the interoperation protocol of a higher level, any device can be freely connected thereto and easily controlled in the IP-based networks.

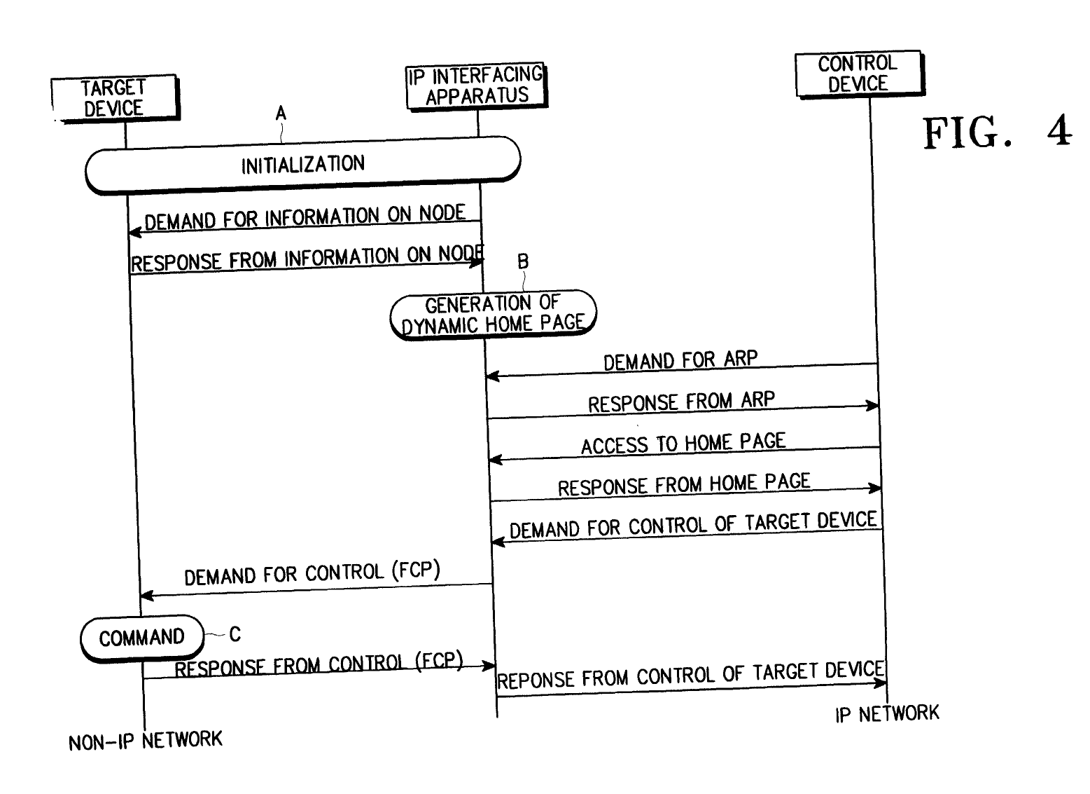

FIG. 4 is a flow chart illustrating the flow of a control signal in accordance with an IP protocol having the stack in FIG. 2.

As stated above, the IP interfacing apparatus may be embodied in an independent style or may perform the same function as a part of a particular apparatus.

When there is a reset, initialization occurs between the IP interfacing apparatus and the target devices of the non IP-based networks (step A). Under this state, the IP interfacing apparatus demands information from the node, and collects the information from the node if the target devices respond to the demand. If the collected information finds that the non IP-based target devices are predetermined, a home page is constructed to provide the functions of the apparatus (step B). Once construction of the home page is complete, the control device of the IP-based networks gets access to the home page so as to get access to the target devices of the non IP-based networks. Thus, the necessary control can be attempted under this state.

The command from the control device is converted to the control command pertinent to the target devices, which receives the control command. The target devices then perform a relevant operation in accordance with the converted control command (step C).

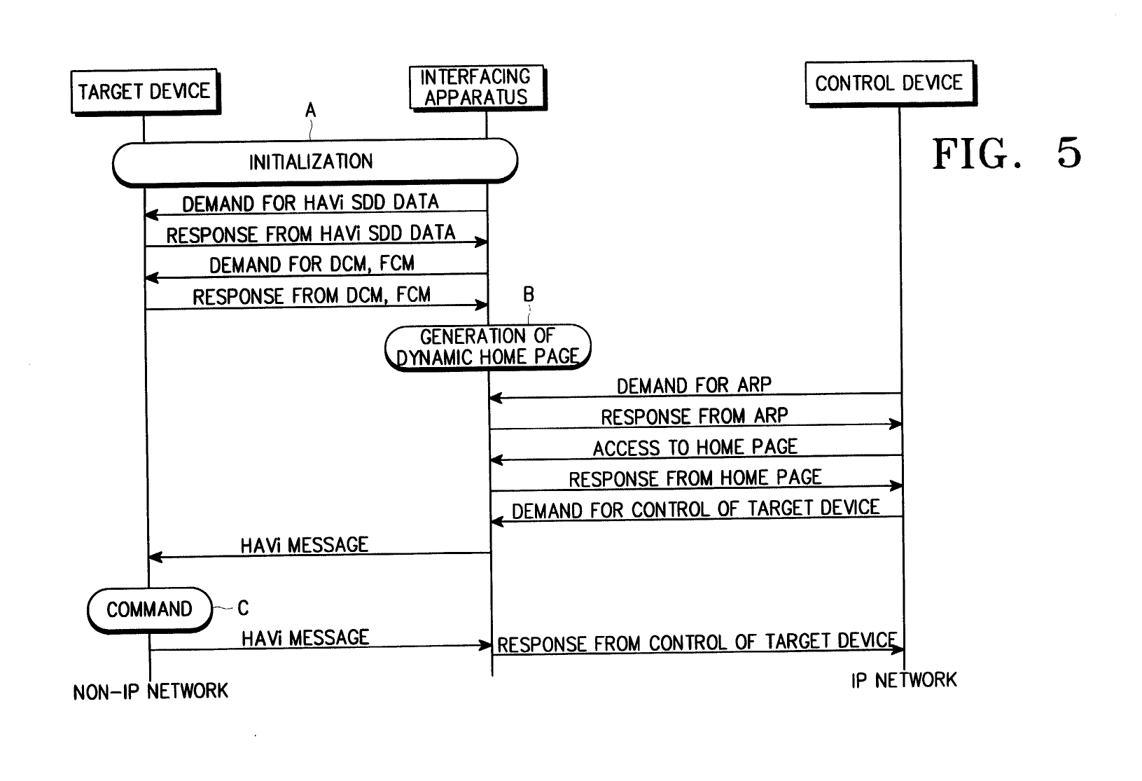

FIG. 5 is a flow chart illustrating the flow of a control signal in accordance with an IP protocol having the stack in FIG. 3.

The state of applying the HAVi as an internal operative protocol is shown in FIG. 5. The flow of basic operation and control signal is the same as in FIG. 4.

To be specific, initialization is performed between the target devices of the non IP-based networks and the IP interfacing apparatus (step A). The operation in FIG. 5 is the same as in FIG. 4 but the flow of collecting the information on the target devices is different. Information is exchanged within the scope allowed by HAVi according to the flow of the control signal as shown in FIG. 5. Ultimately, all the functions of the target device assisting in the HAVi can be learned through that process. Once a dynamic home page is constructed as a result of the flow of the control signal (step B), the IP network control device demands control of a particular function through the constructed home page. At that time, the control information is exchanged between the non IP-based network target devices by means of the HAVi. The target devices perform operation in accordance with the relevant command (step C), and respond to the control signal with respect to the demanded functional control.

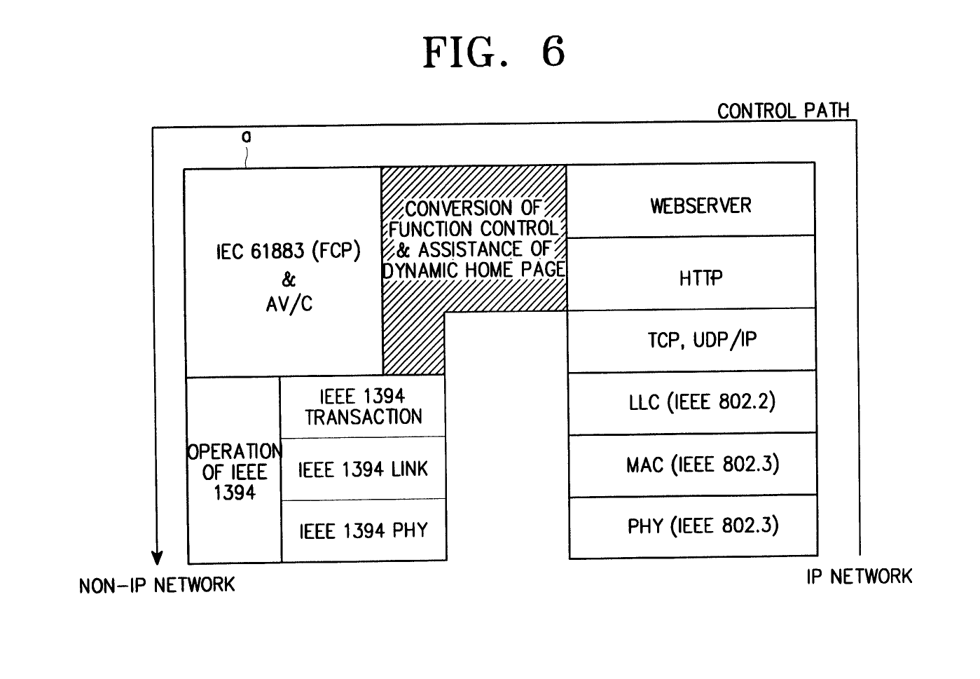

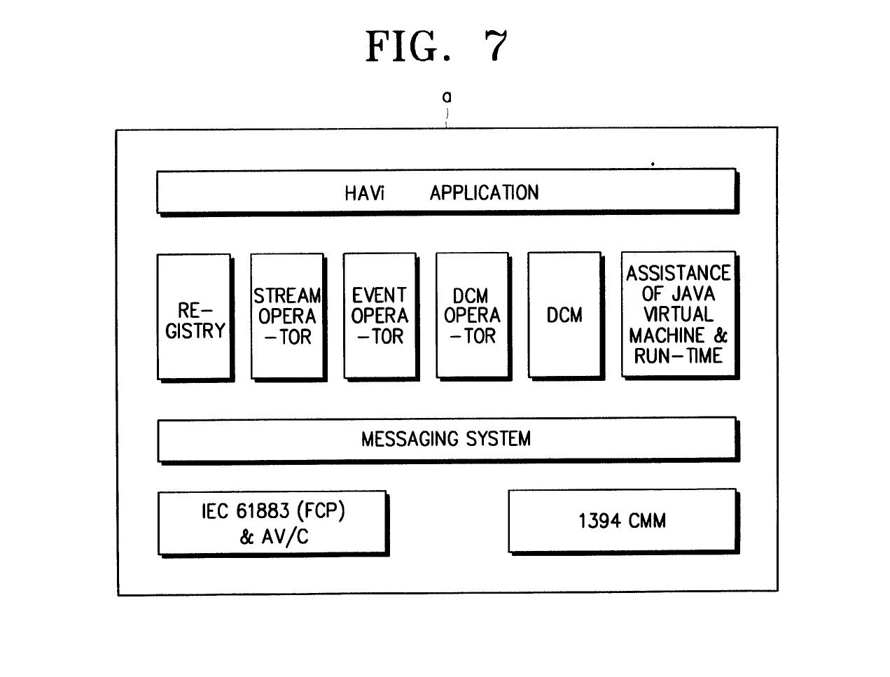

The actual embodiments of the present invention are shown in FIGS. 6 and 7.

FIG. 6 is a block diagram illustrating a stack of an IP interface apparatus according to an embodiment satisfying IEEE1394 and the Ethernet pact. Referring to FIG. 6, the non IP-based networks represent the state of applying IEEE1394 (IEEE std 1394; referred to as a “shielding wall” by Apple Computer Inc.), which is an interface in a high speed series, while the IP-based networks represent the state of applying Ethernet (IEEE std 80).

In FIG. 6, the IP-based networks apply Ethernet, and the non IP-based networks apply IEEE1394. In Ethernet, the two layers of PHY and LINK, in a reference model of Open System Interconnection (OSI—seven layers), are reclassified into three layers of PHY, MAC and LLC. IP is a basis of the upper layer in a local area network (LAN) that applies Ethernet. The layers of PHY and MAC are generally embodied as hardware, while the upper layers of LLC are embodied as software.

IEEE1394 of the non IP-based networks is applicable to household A/V appliances, and does not use IP in general, although IPover1394 may be applicable to particular cases. The IEEE1394 mainly comprises the layers of PHY and LINK. As shown in FIG. 6, the TRANSACTION layer exists above the LINK layer as a software-functioning block, and a bus management block in series exists throughout the layers of PHY, LINK and TRANSACTION. This is the state of layers suggested in the specification of IEEE1394.

In an embodiment of the present invention, IEC61883 and AV/C are used as a function control protocol of an upper layer of the TRANSACTION layer. The IEC61883 and AV/C are the protocols primarily used when IEEE1394 is applicable to A/V appliances. The interface shown in FIG. 6 has the same constitution as illustrated in FIG. 2 as a reference.

Also, the web access to IP-based networks, which was one of the conditions in FIG. 2, is available. The function control protocol in non IP-based networks can also perform its own function by means of IEC61883 and AV/C.

FIG. 7 is a block diagram illustrating a varied stack of an IP interface apparatus according to another embodiment satisfying IEEE1394 and the Ethernet pact. Referring to FIG. 7, Ethernet is applied in the IP-based networks, as in the interfacing apparatus shown in FIG. 6, while IEEE1394 is applied in the non IP-based networks. In the upper layer of Ethernet, TCP/IP, HTTP, and the web server can be constructed. HAVi, which is one of the interoperation protocols shown in FIG. 3, is applied in the IEEE1394 network. Since HAVi basically uses TEEE1394, such application is appropriate.

Each function block of HAVi shown in FIG. 7 represents the state of applying the software function blocks suggested by the HAVi standard. The blocks of IEC61883 and AV/C are not subordinate to HAVi, but are reserved to assist in the case where the apparatus cannot assist in HAVi.

Between the systems using HAVi, all the functions of the counterpart apparatuses are grasped by means of DCM and FCM, etc., and those functions can be controlled by delivering a HAVi message. Therefore, the interfacing apparatus, according to the present invention, can easily grasp and control the functions of the interfacing apparatus shown in FIG. 7, as well as the IEEE1394 system assisting in the non-predetermined HAVi, when they are newly accessed. Meanwhile, a description of each function block of the HAVi can generally be found in the specifications of HAVi.

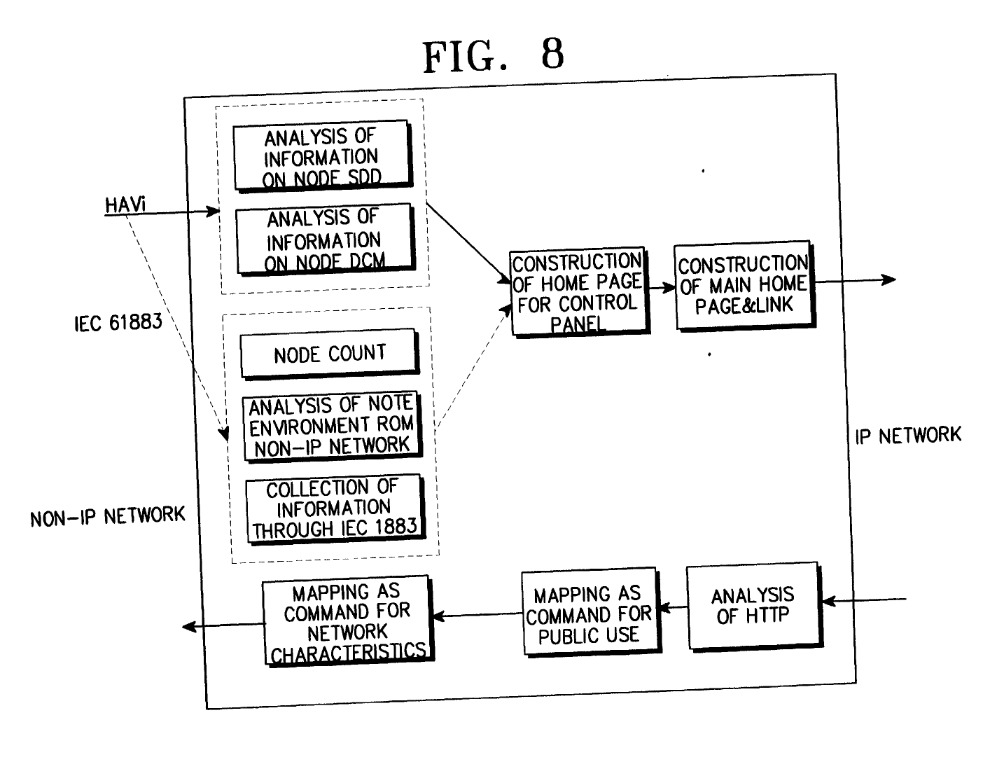

FIG. 8 is a block diagram illustrating an embodiment of an inner structure of a converting section commonly shown in FIGS. 6 and 7. FIGS. 6 and 7 show different interface blocks positioned on the side of the non IP-based networks.

FIG. 8 shows both the operational constitution of the interface when IEC61883 is applied and the constitution of the interface when HAVi is applied.

The following is a description of the operational constitution of the interface when IEC61883 is applied as stated above.

First, basic information from the node is obtained by directly controlling IEEE1394 as a method for determining the node count and collecting information on non IP-based networks by reading the environment setting ROM of each node. The kinds of pertinent devices are determined by collecting the information from each node through the IEC61883 block. Based on the analysis of information from nodes SDD and DCM and a determination of node count, as well as through an analysis of the node environment setup ROM, a home page for a control panel is constructed. A main home page is subsequently constructed and linked.

Second, a command requesting non-IP based network characteristics is converted to an AV/C command used for IEC61883.

The constitution of the interface is as follows when HAVi is applied.

First, information from each node is collected through a HAVi block used for collecting information from the node of non IP-based networks. Here, analysis is made on the number of nodes, a list of functions of each node, and the contents of SDD and DCM for each node obtained by the HAVi block. Second, the command requesting the non IP-based network characteristics is converted to a format understandable by the HAVi block so as to interface with the HAVi block.

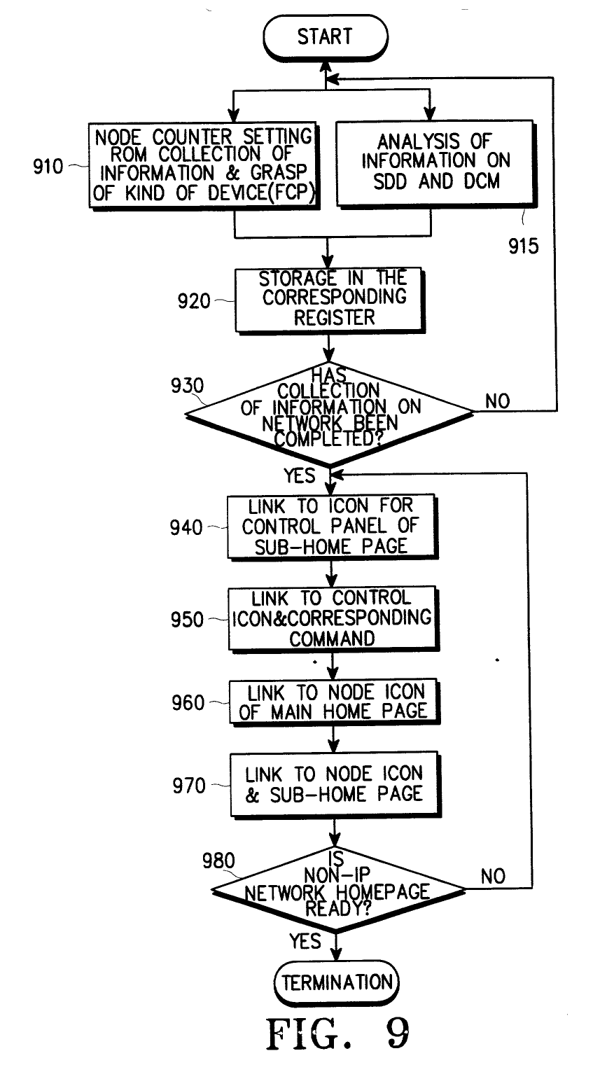

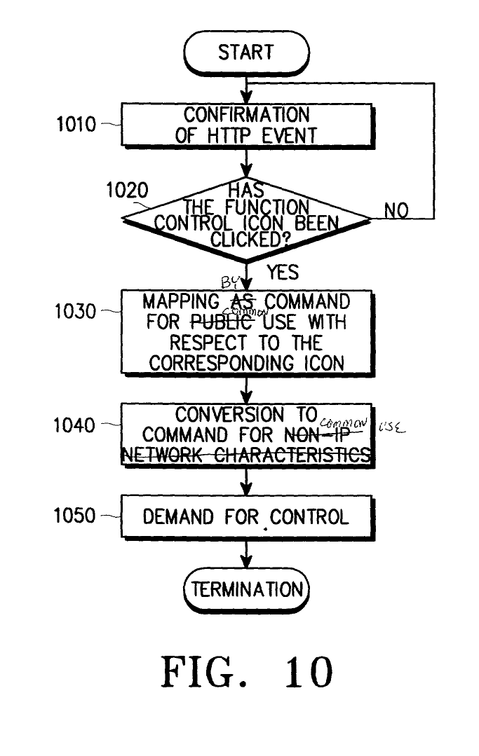

Meanwhile, FIGS. 9 and 10 show a reversal of the flow of control directed from the block of a non IP-based network to the block of an IP-based network.

FIG. 9 is a flow chart illustrating the state of interfacing from a non IP-based network to an IP-based network and construction of a dynamic home page, according to a preferred embodiment of the present invention. FIG. 10 is a flow chart illustrating the state of interfacing from a non IP-based network to an IP-based network and construction of a dynamic home page, according to another preferred embodiment of the present invention. The controls here are performed by an operation of the function block shown in FIG. 8.

The following is a brief description of the controls shown in FIGS. 9 and 10. In step 910, information from the ROM of the node counter and environment setup information is collected, and the kind of device is determined. In step 915, information on the SDD and DCM is analyzed. In step 920, the results of the steps 910 and 915 are stored in the registry. In step 930, whether the network information has been completely obtained is determined. If it is determined to have been completed, an icon for a control panel in a sub-home page is linked in step 940. The control icon is linked to the corresponding command in step 950. The node icon of the main home page is linked in step 960, and the node icon is linked to the sub-home page in step 970. In step 980, it is checked whether the non IP-based network home page is fully prepared. Upon checking, the entire process is completed.

Subsequently, operation of the interfacing apparatus according to the present invention is prepared.

FIG. 10 shows a process of controlling the pertinent device in operation in FIG. 9.

In step 1010, the HTTP event is confirmed. In step 1020, it is determined whether the function control icon has been clicked. In the affirmative, the function control icon is mapped by a command for common use to the pertinent icon in step 1030. In step 1040, the characteristic command for the non IP-based networks is converted to the command for common use. In step 1050, a control demand corresponding to the converted command is made.

Personal computers, as an example, embody the functions described above as a part of a particular apparatus. PC cards for pertinent networks are connected, and in the functions described above, the remaining links can all be embodied as software.

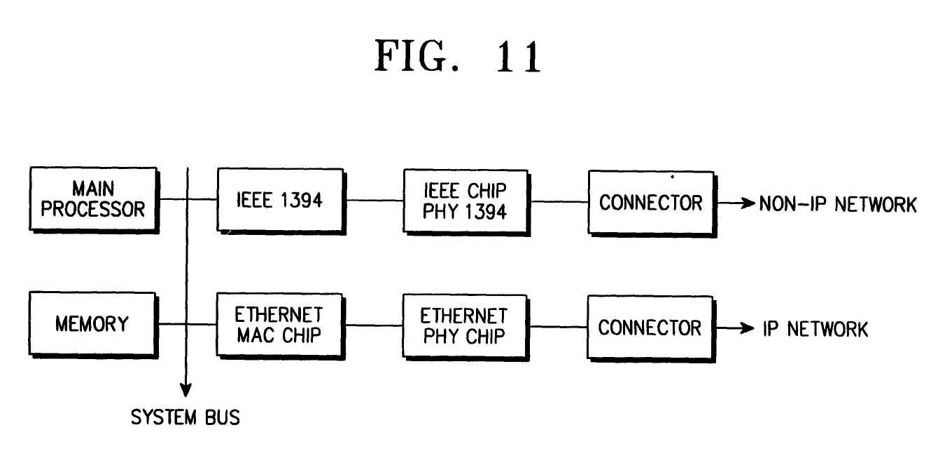

FIG. 11 shows an example of an independent embodiment of the above apparatus. The apparatus can be simply comprised of a link assisting in each corresponding network, PHY chips, a main processor and a memory to embody the remaining functions in software.

Ethernet is applied for an IP-based network, while IEEE1394 is applied for a non IP-based network. For Ethernet, the layers of PHY and MAC are only embodied as hardware, while the other layers can be embodied as software. To enhance performance of the interfacing apparatus, a main processor of high performance may be used. Otherwise, either a packet conversion or functions frequently using memory may be embodied in software.

In short, two models are suggested for remotely controlling a non IP-based network device with an IP-based network device, according to a preferred embodiment of the present invention.

The two models are variable depending on how many functions the protocol assisting in each of the IP-based network devices have. To easily control each device in the non IP-based networks over the internet, the constitution of the interoperation protocol, as suggested in FIG. 3, can be standardized and applied. Therefore, the interfacing apparatus as shown in FIG. 3, can be used.

Accessing the internet from a non IP-based network device poses a problem under the conventional technology because it is impossible to memorize all the IP devices in the interfacing apparatus and relay the memorized information to a IP-based network device.

However, a device that accesses the internet via a non IP-based network device and an interfacing apparatus should assist in TCP/IP. In the case where the IEEE1394 interface is in series, the IPover1394 standard is set. Thus, the PC having the IEEE1394 interface may attempt to access the internet in the same way as in the IP-based network. In that case, the following three particulars need to be modified in the model of FIG. 3.

First, IPover1394 should be applied as an upper layer of the non IP-based network link.

Second, a function block is required to convert the IEEE1394 packet to an IP-based network packet format.

Third, when the IP-based IEEE1394 apparatus is not given a public IP address due to insufficiency of IP addresses, a private IP address should be assigned. Also, the protocols administering the private IP address such as DHCP and NAPT should be applied.

As described above, the present invention provides an ability to remotely control certain electronic devices in non IP-based networks.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An internet protocol (IP) interfacing apparatus for controlling predetermined target devices for non IP-based networks with other predetermined target devices for IP-based networks, comprising:
a dynamic home page assisting section for processing a dynamic homepage by collecting information on said predetermined target devices for non IP-based networks and assisting in construction of a dynamic web server; and
a function control converting section for converting a function control demand by one of said IP-based networks to a function control command for one of said non IP-based networks by converting a predetermined function selected in at least one of said IP-based networks to a control command in at least one of said non IP-based networks.

2. The IP interfacing apparatus of claim 1, wherein said dynamic home page assisting section assists in processing said dynamic home page by assisting in construction of said dynamic web server after collecting information on said non IP-based network target devices through a function control protocol.

3. The IP interfacing apparatus of claim 1, wherein said dynamic home page assisting section assists in processing said dynamic home page by assisting in construction of said dynamic web server after collecting information on said non IP-based network devices through an interoperation protocol.

4. The IP interfacing apparatus of claim 1, wherein said IP-based networks are accessible over the internet, and said non IP-based networks have a protocol standardized for controlling functions between devices.

5. The IP interfacing apparatus of claim 4, wherein said protocol is standardized in such a way that information is provided, said information includes functions of the target devices in said non IP-based networks.

6. The IP interfacing apparatus of claim 3, wherein said interoperation protocol applicable to said non IP-based networks is HAVi based on an IEEE1394 interface.

7. A method for controlling non IP-based network target devices in an IP interfacing apparatus that assists in processing a dynamic home page in accordance with assistance in construction of a dynamic web server, by collecting information on predetermined target devices for non IP-based networks, and converting a function control demand by an IP-based network to a function control command for a non IP-based network by converting a predetermined function selected in at least one of a plurality of IP-based networks to a control command in at least one of the non IP-based networks, said method comprising:
a first step of initializing between said IP interfacing apparatus and one of the non IP-based network target devices;
a second step of demanding information from a node by said IP interfacing apparatus, and collecting information from said node when one of said target devices responds thereto;
a third step of constructing a home page which can provide functions of said target devices based on the collected information from said node if said target devices are found to be predetermined devices;
a fourth step of connecting a control device of said at least one of said plurality of IP-based network to said home page so that said control device accesses and controls at least one of said target devices;
a fifth step of controlling said at least one of said target devices of said non IP-based networks by converting the command from said control device to the control command relevant to said at least one of said target devices and receiving a response from said at least one of said target devices; and
a sixth step of performing an operation in accordance with said converted control command relevant to said at least one of said target devices.

8. The method of claim 7, further comprising a step of exchanging information on regulation of HAVi pertinent to a particular function as demanded between said predetermined non IP-based network target devices when said control device of said IP-based networks requests control of a particular function through the constructed home page.
